(19) United States
(12) Patent Application Publication
(10) Pub. No.: US 2009/0019236 A1
(43) Pub. Date: Jan. 15, 2009

(54) Data write/read auxiliary device and method for writing/reading data

(76) Inventors: Wei-Chiang Hsu, Taichung (TW); Yu-Cheng Hsu, Yilan (TW); Peng-Yu Huang, Taipei (TW); Tsung-Lin Yu, Taipei (TW); Chang-Wei Chung, Changhua (TW); Hen-Jui Liang, Nan Tou (TW)

Correspondence Address: CLARK & BRODY, 1090 VERMONT AVENUE, NW, SUITE 250, WASHINGTON, DC, 20005, US

(21) Appl. No.: 12/216,854

(22) Filed: Jul. 11, 2008

(30) Foreign Application Priority Data
Jul. 12, 2007 (TW) 096125352

(51) Int. Cl. G06F 12/00

(52) U.S. Cl. 711/147; 711/E12.001

(57) ABSTRACT

A data write/read auxiliary device and method for writing/reading data are provided. A data storage unit and a program storage unit are installed in the data write/read auxiliary device, wherein the program storage unit is for storing automatic execution program and protection program. When the data write/read auxiliary device is connected to a data processing device, the automatic execution program is executed for automatically executing programs stored in the program storage unit. The protection program is executed for executing an access process on data storage unit to judge whether driving a write/read head or not based on outcome of the access process when a file sharing software is executed for data downloading and uploading. Through the data storage unit as a buffer area of data before writing/reading data on a hard disk, the data write/read auxiliary device and method for writing/reading data can protect the hard disk.

### BACKGROUND OF THE INVENTION

1. Field of the Invention

This invention generally relates to a data write/read auxiliary device and method for writing/reading data, and more specifically, to a data write/read auxiliary device and method for writing/reading data, which are capable of preventing head of the hard disk from frequent rotation, also preventing frequent writing to/reading from sector of the hard disk while uploading data and downloading data from hard disk via network system.

2. Description of Related Art

The advancement of information electronization is being rapidly promoted due to the vigorous developments in network, electronic and computer technologies, thereby enabling users to access required information via Internet with great convenience; for instance, the peer-to-peer (P2P) in the Internet technology allows all participants, namely clients, to provide resources based on bandwidth and calculation power of participants of a network, but no longer relying on only a few server as in the past; due to the dominance of the peer-to-peer network, various varieties of file sharing software have been popularly utilized, such as BitTorrent protocol or eMule.

FIG. 1 is a system architecture block diagram illustrating a local computer of a prior file requester using a file sharing software to upload or download data via network system; as shown in the FIG., after the file requester's local computer 1 is installed with the file sharing software 130 in a hard disk 13, the local computer 1 is connected to a tracker server 3 of a network system, e.g. an Internet, via a network unit 11 of the local computer 1, namely a network interface, and then the tracker server is to react to request of the local file requester, thereby providing the local file requester with IP addresses of other requesters 30, 31, and 32, including resources providers, and then enabling the file requester of local computer 1 to further connect to other file requesters 30, 31, 32 via the network unit 11; meanwhile, providing file requester of the local computer and other file requesters 30, 31, and 32 to inform one another of one's own segment based on data recorded by the file sharing software 130, namely verification codes of downloaded data segments, as well as exchanging necessary data with one another without involving with other servers, and further dispensing data flow amount of single line, thereby reducing server's workload; this kind of file sharing software is characterized by providing comparatively wide bandwidth when there are more file requesters for downloading, also enabling the file requesters to quickly become resources providers, and when there are more resources providers, download speed becomes faster.

The file sharing software enables file requesters to download resource speedily, however, after a file requester downloaded resource, the file sharing software also provides the downloaded resource saved by the file requester to other file requesters for downloading, in other words, the role of the file requester becomes a data uploader from a data downloader, and during the role changing process, causing a write/read head of hard disk that is used to store downloaded data and uploaded data to continuously rotate and frequently access to a specific sector, namely, after data downloaded by the network unit 11 of the local computer 1 is temporarily saved in a memory 12 of a central processing unit (CPU) 10, the central processing unit 10 commands the write/read head of the hard disk 13 to write in the data being temporarily saved in the memory 12 according to file download storage sectors set by the file sharing software 130, not shown in the FIG., and later, when other file requester 30, 31, or 32 sends out a download request, the central process unit 10 commands the write/read head of the hard disk 13 to access the downloaded data saved in the file download storage sectors of the hard disk 13, and also to temporarily save the accessed downloaded data in the memory 12, thereby providing the network unit 11 to upload data temporarily saved in the memory 12 via the network system 2 according to IP address of other file requester 30, 31, or 32; and number of accessing data to be uploaded from the file download storage sectors of the hard disk 13 depends on number of file requester. In view of the above, this kind of file sharing software is to cause the write/read head of the hard disk 13 to frequently read from some specific hard disk sectors, likely to damage magnetic nature of magnetic tracks of hard disk, and also likely to cause tracks damaged, thereby further slowing down write/read speed of hard disk; and in a more serious situation, the hard disk is damaged and then the computer has a boot-up problem.

Since modern computer has a very powerful processing capability, also being capable of accessing requested data via network speedily, with all the convenience provided by the modern computer, humans' daily life and work has become inseparable from the computer; and since hard disk takes a very important role as an accessory of the modern computer, for those file requesters who frequently apply foresaid file sharing software to download data from the network, it has become a highly urgent issue how to reduce hard disk damage rate while carrying out objective of obtaining information from the network.

### SUMMARY OF THE INVENTION

In view of the disadvantages of the prior art mentioned above, it is a primary objective of the present invention to provide a data write/read auxiliary device and method for writing/reading data, which are capable of reducing rotation frequency of hard disk write/read head of data processing device and reducing access frequency to hard disk sectors, thereby further protecting the hard disk.

To achieve the aforementioned and other objectives, a data write/read auxiliary device and method for writing/reading data are provided according to the present invention. When a file sharing software is executed by a data processing device to download data from a network system and save the downloaded data to the hard disk of the data processing device and to upload data to be uploaded from the hard disk to the network system, the data write/read auxiliary device can reduces rotation frequency of write/read head of the hard disk as well as reduces access frequency to sectors of the hard disk to protect the hard disk. The data write/read auxiliary device comprises: an interface unit for connecting the data write/read auxiliary device to the data processing device; a data storage unit connected to the interface unit; and a program storage unit connected to the interface unit and used for storing automatic execution program and protection program. The automatic execution program enables the data processing device to automatically execute all programs saved in the program storage unit when the data write/read auxiliary device is connected to the data processing device. The protection program is executed after identifying the data write/read auxiliary device by the data processing device, and the protection program is for reading storage sector addresses of the hard disk set by the file sharing software for storing the downloaded data and the data to be uploaded while the data processing device is executing the file sharing software. When the file sharing software is executing a process of downloading data, the protection program judges if a storage space provided by the data storage unit is sufficient to save the downloaded data, and saves the downloaded data to the data storage unit and further to an idle area of the storage sector of the hard disk according to the storage sector addresses when the storage space is sufficient; or deletes data stored in the data storage unit to save the downloaded data to the data storage unit and further to the idle area of the storage sector of the hard disk according to the storage sector addresses when the storage space is insufficient. When the file sharing software is executing a process of uploading data, the protection program judges if the data to be uploaded is stored in the data storage unit, and uploads the data to be uploaded to the network system when the data to be uploaded is stored in the data storage unit; or retrieves the data to be uploaded from the storage sector of the hard disk according to the storage sector addresses to upload the data to be uploaded to the network system, and further save the data to be uploaded to the data storage unit when the data to be uploaded is not stored in the data storage unit. Before the data to be uploaded is saved to the data storage unit, the protection program judges if a storage space provided by the data storage unit is sufficient to save the retrieved data. When the storage space is sufficient, the retrieved data is saved to the data storage unit; and when the storage space is insufficient, data stored in the data storage unit is deleted, and then the retrieved data is saved to the data storage unit.

In another embodiment of the data write/read auxiliary device of the present invention, the data write/read auxiliary device is for saving data downloaded by a data processing device via network system or enabling the data processing device to upload the stored downloaded data. The data write/read auxiliary device comprises at least: an interface unit for connecting the data write/read auxiliary device to the data processing device; a data storage unit connected to the interface unit; and a program storage unit connected to the interface unit and used for storing automatic execution program and data write/read program. The automatic execution program enables the data processing device to automatically execute all programs saved in the program storage unit when the data write/read auxiliary device is connected to the data processing device. After identifying the data write/read auxiliary device by the data processing device, a data storage unit is set as a data storage destination and the data write/read program is executed for searching a provider that is able to provide local end of the data processing device with requested data via the network system, and downloading the requested data provided by the provider via the network system and storing the downloaded data in the data storage unit that is set as the data storage destination; and while receiving a request of data demand sent via the network system, responsively retrieving the saved downloaded data corresponding to the request of data demand from the data storage unit that is set as the data storage destination, and then uploading the retrieved data to the requester providing the request of data demand via the network system.

Method for writing/reading data of the present invention is for reducing rotation frequency of write/read head of the hard disk as well as reducing reading frequency on sectors of the hard disk to protect the hard disk when a file sharing software is executed by a data processing device for saving downloaded data from a network system to the hard disk of the data processing device and uploading data to be uploaded from the hard disk to the network system. The method for writing/reading data comprises: executing an automatic execution program by the data processing device for automatically executing all programs stored in a program storage unit; executing a protection program stored in the program storage unit by the data processing device to read storage sector addresses of the hard disk in which the downloaded data and the data to be uploaded are saved when the data processing device is executing the file sharing software; commanding the protection program to judge if a storage space provided by the data storage unit is sufficient to save the downloaded data when the file sharing software is executing a process of downloading data, and saving the downloaded data to the data storage unit and further to an idle area of the storage sector of the hard disk according to the storage sector addresses by the protection program when the storage space is sufficient, or deleting data stored in the data storage unit to save the downloaded data to the data storage unit and further to the idle area of the storage sector of the hard disk according to the storage sector addresses when the storage space is insufficient; and commanding the protection program to judge if the data to be uploaded is stored in the data storage unit when the file sharing software is executing a process of uploading data, and uploading the data to be uploaded from the data storage unit to the network system when the data to be uploaded is stored in the data storage unit, or retrieving the data to be uploaded from the storage sector of the hard disk according to the storage sector addresses to upload the data to be uploaded to the network system and further saving the data to be uploaded to the data storage unit when the data to be uploaded is not stored in the data storage unit.

In another embodiment of method for writing/reading data of the present invention, the method for writing/reading data is for saving data downloaded by a data processing device via a network system and for enabling the data processing device to upload the saved downloaded data via the network system. The method for writing/reading data comprises: executing an automatic execution program by the data processing device for automatically executing all programs saved in a program storage unit, and setting a data storage unit as a data storage destination; executing a data write/read program stored in the program storage unit by the data processing device for searching a provider that is capable of providing local client of the data processing device with requested data, and then downloading data provided by said provider via the network system and saving the downloaded data in the data storage unit that is set as the data storage destination; and when receiving a request of data demand sent via the network system, responsively retrieving the saved downloaded data corresponding to the request of data demand from the data storage unit that is set as the data storage destination, and then uploading the retrieved data to the requester providing the request of data demand via the network system.

Compared with prior techniques of downloading and uploading data by file sharing software, the data write/read auxiliary device and method for writing/reading data of the present invention are characterized by using a data storage unit as a buffer area of data before writing/reading data to/from a hard disk, thereby avoiding frequent reading on the hard disk for retrieving requested file while receiving a plurality of file sharing requests sent from network system. According to the prior art, when the file sharing software is used to speedily download requested files, frequent access to particular sectors of the hard disk in which downloaded data are stored always happens due to executing the file sharing software. By contrast, since the data storage unit of the present invention is capable of providing the requested file to the file requesters of the network system, the frequent reading on the hard disk is avoided, thereby protecting the hard disk.

### BRIEF DESCRIPTION OF DRAWINGS

The present invention can be more fully understood by reading the following detailed description of the preferred embodiments, with reference made to the accompanying drawings, wherein:

FIG. 1 is a system architecture block diagram illustrating a local computer of a file requester using a file sharing software to upload or download data via a network system in the prior art;

FIG. 2 is a basic architecture block diagram illustrating a first embodiment of a data write/read auxiliary device of the present invention applied to a data processing device;

FIG. 3 is a diagram illustrating content stored in a program storage unit of the first embodiment of the data write/read auxiliary device of the present invention;

FIG. 4 is a basic architecture block diagram illustrating a second embodiment of the data write/read auxiliary device of the present invention applied to a data processing device;

FIG. 5 is a basic architecture block diagram illustrating a third embodiment of the data write/read auxiliary device of the present invention applied to a data processing device;

FIG. 6 is a basic architecture block diagram illustrating a fourth embodiment of the data write/read auxiliary device of the present invention applied to a data processing device;

FIG. 7 is a diagram illustrating content stored in a program storage unit of the fourth embodiment of the data write/read auxiliary device of the present invention;

FIG. 8 is a flow chart illustrating process of executing data download according to a first embodiment of method for writing/reading data of the present invention;

FIG. 9 is a flow chart illustrating process of executing data upload according to the first embodiment of method for writing/reading data of the present invention; and

FIG. 10 is a flow chart illustrating process of executing data download and upload according to a second embodiment of method for writing/reading data of the present invention.

### DETAILED DESCRIPTION OF PREFERRED EMBODIMENTS

The following illustrative embodiments are provided to illustrate the disclosure of the present invention; those in the art can apparently understand these and other advantages and effects after reading the disclosure of this specification. The present invention can also be performed or applied by other different embodiments. The details of the specification may be on the basis of different points and applications, and numerous modifications and variations can be devised without departing from the spirit of the present invention.

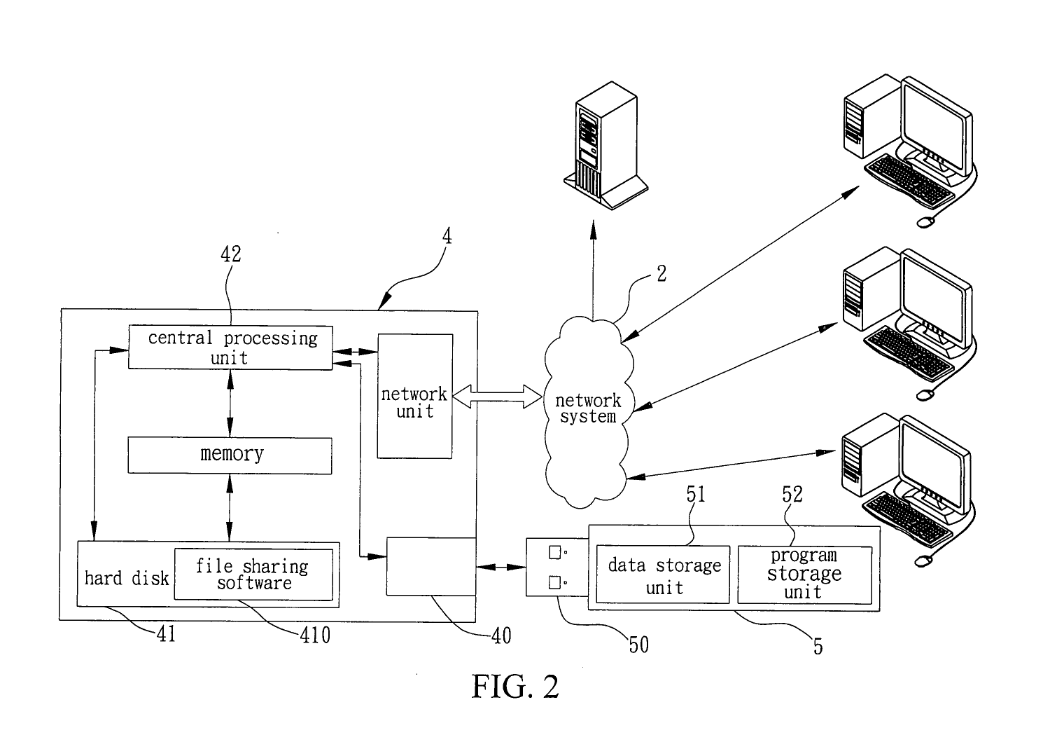

FIG. 2 is a basic architecture block diagram illustrating a first embodiment of the data write/read auxiliary device of the present invention applied to a data processing device. As shown in the FIG. 2, the data processing device 4 is an electronic device, e.g. desk computer, notebook computer, etc., that has hard disk and is capable of saving data downloaded from the network system 2 to a local hard disk 41 and uploading data stored in the hard disk 41 to the network system 2. The hard disk 41 of the data processing device 4 of the present embodiment is installed with a file sharing software 410, and the file sharing software 410 is for executing foresaid processes of downloading and uploading data. The data write/read auxiliary device 5 of the present embodiment is an USB portable disk, for instance. The data write/read auxiliary device 5 is applied to reduce rotation frequency of a hard disk write/read head of the data processing device 4 and to reduce access frequency to particular sectors of the hard disk, thereby protecting the hard disk. The data write/read auxiliary device 5 comprises an interface unit 50, a data storage unit 51, and a program storage unit 52.

The interface unit 50 is for connecting with the data processing device 4, in the present embodiment, connection head of an Universal Serial Bus (USB) is applied as the interface unit 50 to connect with the data processing device 4, correspondingly, the data processing device 4 includes an USB interface 40 compatible with the interface unit 50. Applying USB enables the interface unit 50 to support Hot Plug and Plug & Play, therefore, after the data write/read auxiliary device 5 is connecting to the data processing device 4, the data processing device 4 sends out a connection request for allowing the data processing device 4 to execute the automatic execution program 520, and the data processing device 4 automatically downloads required driver programs, thereby establishing a communication channel with the data write/read auxiliary device 5.

However, it must be stated herein, connection mode between the data processing device 4 and the data write/read auxiliary device 5 is not restricted to foresaid USB interface, in other words, the interface unit 50 of the data write/read auxiliary device 5 can also apply a wireless connection interface to establish a communication channel with the data processing device 4, such as USB device of ultra-wideband (UWB) wireless communication technology, namely, depending on practical application mode, but not restricted to the description and illustration herein.

The data storage unit 51 is connecting with the interface unit 50 and is used as a buffer area of data before the hard disk 41 of the data processing device 4 saves data downloaded from the network system 2 or before the data processing device 4 uploads data saved in the hard disk 41 to the network system 2, namely, after the file sharing software 410 is executed, a central processing unit 42 of the data processing device 4 executes a process of judging the data storage unit 51 of the data processing device 4 before commanding the hard disk write/read head to perform an action of write to/read from according to file download storage sectors set by the file sharing software 410, wherein the file download storage sectors are storage sectors of the hard disk 41 for saving downloaded data and data to be uploaded. Operating system installed in the data processing device 4 decides if it is necessary to drive the hard disk write/read head to perform an action of write to/read according to outcome of judgment; detailed description of foresaid judgment process will be given later.

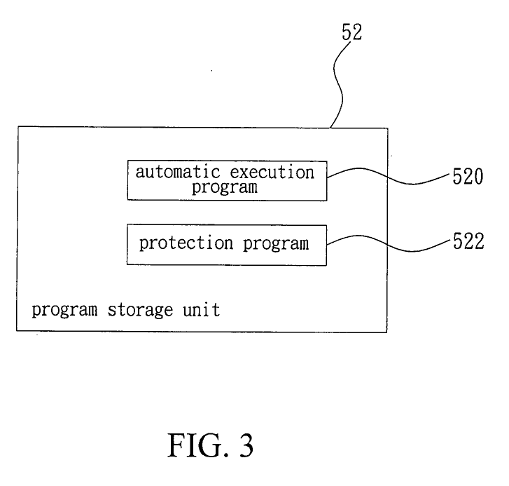

The program storage unit 52 is connecting with the interface unit 50 for storing programs related to driving the data write/read auxiliary device 5 to execute auxiliary processes of writing/reading data. The program storage unit 52 and the data storage unit 51 are flash memories. As shown in FIG. 3, the program storage unit 52 is for storing automatic execution program 520 and protection program 522, when the data write/read auxiliary device 5 is connecting to the data processing device 4, the automatic execution program 520 enables the data processing device 4 to automatically execute all programs stored in the program storage unit 52, in other words, after the data write/read auxiliary device 5 is connecting to the data processing device 4, the data processing device 4 sends out a connection request for allowing the data processing device 4 to execute the automatic execution program 520 stored in the data write/read auxiliary device 5, subsequently the data processing device 4 also executes driver programs stored in local end to identify the data write/read auxiliary device 5, specifically, executing the automatic execution program 520 and driver programs for enabling the data write/read auxiliary device 5 to support Hot Plug and Plug & Play. It should be stated herein that the driver programs can also be stored in the program storage unit 52, depending on specification of operating system installed in the data processing device 4. For example, in a data processing device installed with a Windows operating system, operating system before Windows 2000 version is incapable of identifying any electronic equipment externally connected to the data processing device, therefore, the electronic equipment externally connected to the data processing device has to be installed with the driver program therein, or user must install the driver program for the externally connected electronic equipment via a CD or other storage unit, thereby enabling the data processing device to identify the externally connected electronic equipment and then communicate therewith. In other words, necessity of storing the driver program of the data write/read auxiliary device 5 in the program storage unit 52 depends on specification of operating system installed in the data processing device.

The protection program 522 reads, while the data processing device 4 is executing the file sharing software 410, storage sector addresses of the hard disk 41 set by the file sharing software 410 for storing the downloaded data and the data to be uploaded. And then, each time before the central processing unit 42 commands the hard disk head to execute an action of write to upon receiving a data download request, or before the central processing unit 42 commands the hard disk head to execute an action of read from upon receiving a data upload request sent from the network system, the protection program 522 executes a process of accessing content stored in the data storage unit 51 to judge if it is necessary to drive the hard disk head to execute an action of write to/read from.

Specifically, when the file sharing software 410 is executing a process of downloading data, the protection program 522 judges if the storage space provided by the data storage unit 51 is sufficient to store data to be downloaded, if the storage space is sufficient, then storing the data to be downloaded to the data storage unit 51; and saving the data to be downloaded in an idle area of storage sectors of the hard disk 41 therein no datum is stored according to the storage sector addresses read by the protection program 522; otherwise, if the storage space is insufficient, then deleting data already stored in the data storage unit 51, and then storing the data to be downloaded in the data storage unit 51 and saving the data to be downloaded in an idle area of storage sectors of the hard disk 41 according to storage sector addresses read by the protection program 522.

Furthermore, in the present embodiment, the protection program 522 of the data write/read auxiliary device 5 further provides a sorting process of the downloaded data, for instance, if the downloaded data belong to particular sorts of data, such as commercials, frauds, or viruses, then preventing these sorts of downloaded data from being saved in the hard disk 41 but being saved only in the data storage unit 51 of the data write/read auxiliary device 5, thereby preventing unnecessary data from being stored in the hard disk. Foresaid sorting process is a file type detection process provided by anti-virus software, for example; and in order to simplify present description, no further detailed description thereof is given herein.

According to protocol of the file sharing software 410, when the downloaded data become a request resource to another or a plurality of file requesters of the network system 2, the downloaded data being already stored have to be uploaded to another or a plurality of file requesters sending out requests. When the file sharing software is executing a process of uploading data, commanding the protection program 522 to judge if the data storage unit 51 has already stored the data to be uploaded or not, if the data storage unit 51 has already stored the data to be uploaded, then uploading the data to be uploaded which is already stored in the data storage unit 51 to the network system 2 for providing the data to another or a plurality of file requesters sending out requests. Accordingly, this action of uploading data does not have to drive the hard disk head for accessing storage sectors of the hard disk 41, thereby avoiding repeated reading the data to be uploaded from the storage sectors for uploading data, and further protecting the hard disk.

In another situation, if the data storage unit 51 does not store the data to be uploaded, then retrieving the data to be uploaded from the storage sectors of the hard disk 41 according to storage sector addresses read by the protection program 522 and then uploading the data to be uploaded to the network system 2, and also saving said retrieved data to be uploaded in the data storage unit 51. Since the uploaded data corresponding to the request of uploading demand are generally frequently requested by file requesters, the data to be uploaded is retrieved from the storage sectors of the hard disk 41 to be saved in the data storage unit 51 of the data write/read auxiliary device 5 for providing a great convenience for further responding to requests sent by other file requesters as well as avoiding frequently driving the hard disk head to access to the storage sectors of the hard disk 41.

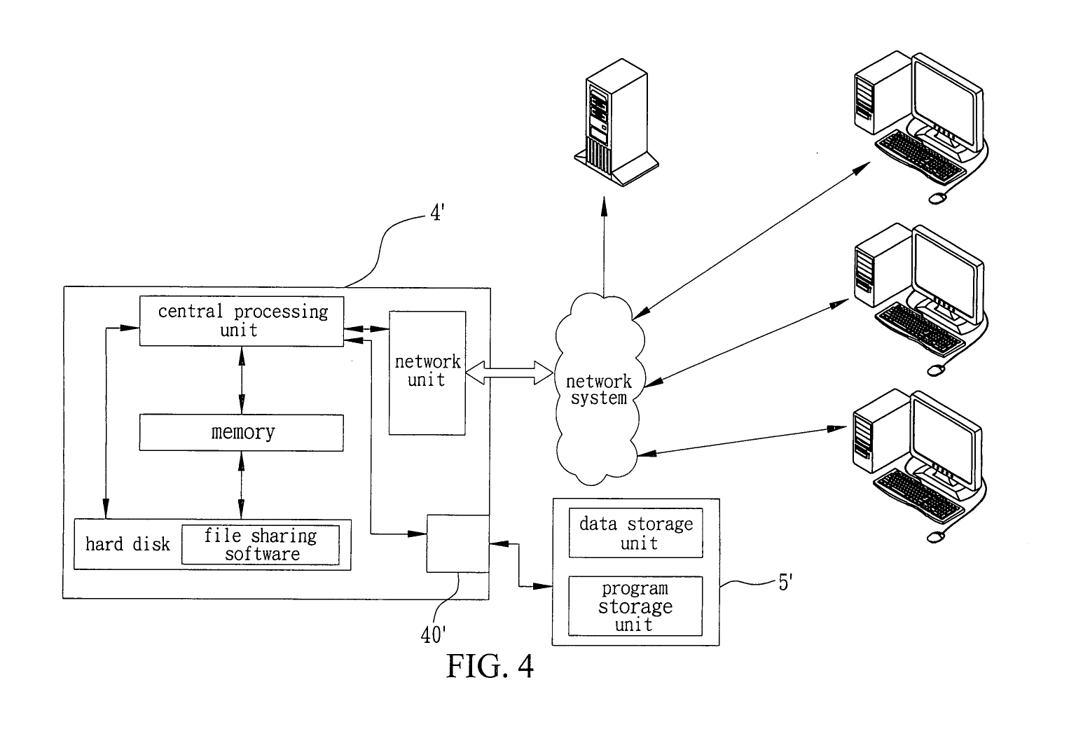

FIG. 4 is a basic architecture block diagram illustrating a second embodiment of the data write/read auxiliary device of the present invention applied to a data processing device. In the present embodiment, mode of connection between data write/read auxiliary device 5′ and data processing device 4′ is different from mode of connection shown in FIG. 2, while operation and process of the remaining components of the present embodiment are the same as those shown in FIG. 2, followed is description of the difference only.

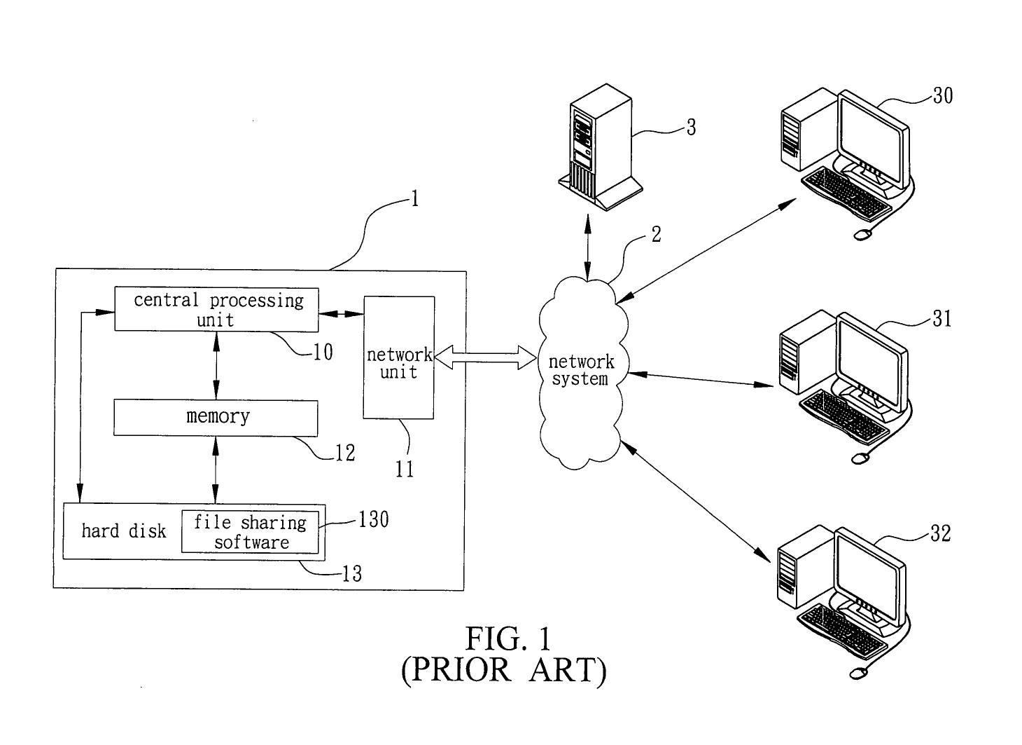

The difference between the present embodiment and the first embodiment shown in FIG. 2 is: the data write/read auxiliary device 5 of the first embodiment shown in FIG. 1 is an USB portable disk, while the data write/read auxiliary device 5′ of the present embodiment is a flash memory card, such as Compact Flash Card (CF card) or Secure Digital Card (SD Card) Accordingly, the data processing device 4′ has to include a card reader 40′ compatible with the data write/read auxiliary device 5′ of the present embodiment, the card reader 40′ can be built inside the data processing device 4′ or externally connected thereto.

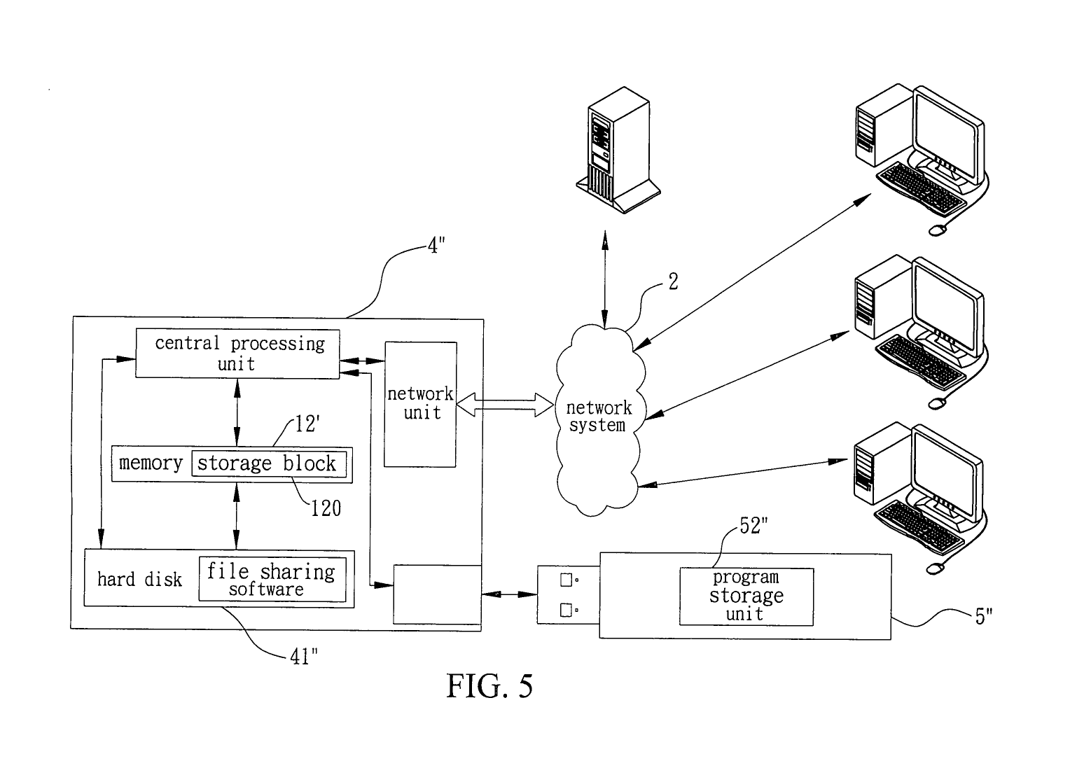

FIG. 5 is a basic architecture block diagram illustrating a third embodiment of the data write/read auxiliary device of the present invention applied to a data processing device. Difference between the present embodiment and the first embodiment shown in FIG. 2 is: the data write/read auxiliary device 5″ of the present embodiment does not have a data storage unit 51 shown in FIG. 2, in other words, before hard disk 41″ of the data processing device 4″ saves data downloaded from the network system 2 or uploads saved data to the network system 2, the data write/read auxiliary device 5″ does not provide a buffer area of data. However, the protection program stored in the program storage unit 52″ will cut a storage block 120 out of storage space provided by memory 12′ of the data processing device 4″ while the data processing device 4″ is executing the file sharing software It should be stated that the cutting process applied herein is similar to a virtual Ramdisk technique, therefore there is no detailed description of the cutting process thereinafter. The storage block 120 is served as a data buffer area before the hard disk 41″ of the data processing device 4″ saves data downloaded from the network system 2 or uploads data to be uploaded to the network system 2. Namely, the storage block 120 obtained from cutting the memory 12′ is the same as the data storage unit stated in the first and the second embodiments, therefore, the present embodiment is capable of achieving the same effect as provided by embodiments shown in FIGS. 2 and 4.

It should be stated herein that an USB portable disk is used as an example for describing the data write/read auxiliary device 5″ of the present embodiment, but not restricted to this type. Any retrievable type flash memory card served as the data write/read auxiliary device 5′ shown in FIG. 4 can also be applied in the present embodiment, in order to simplify illustration, no further diagram is provided herein.

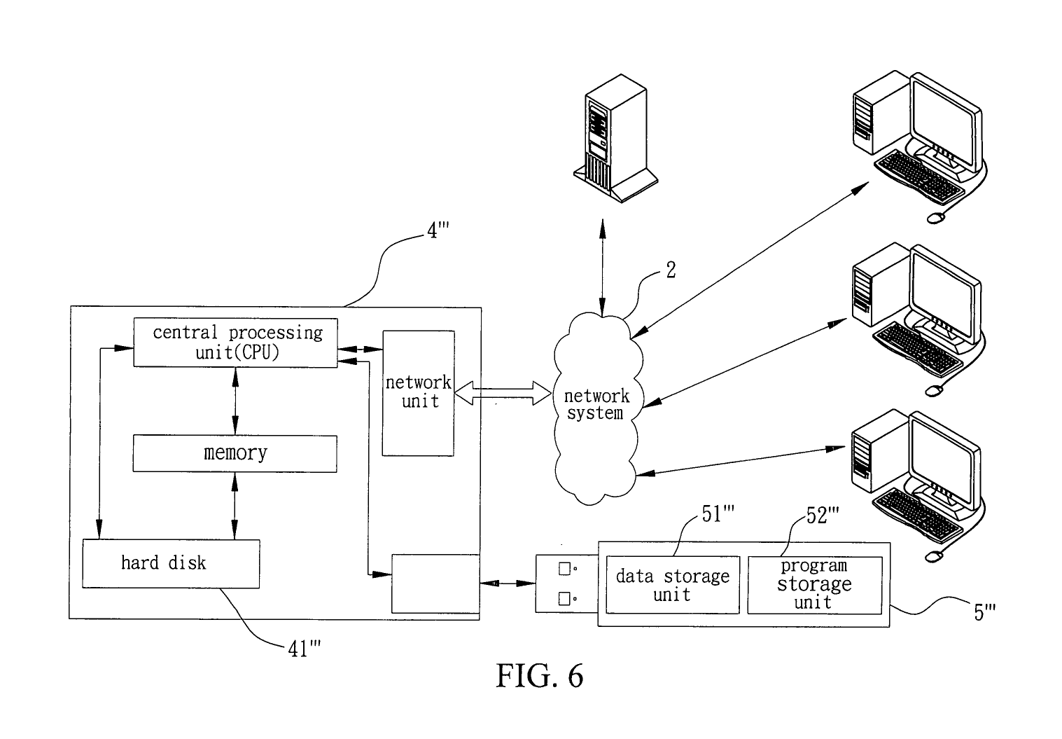

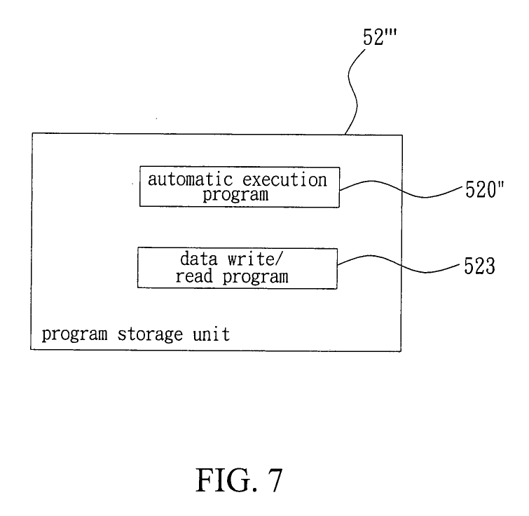

FIG. 6 is a basic architecture block diagram illustrating a fourth embodiment of the data write/read auxiliary device of the present invention applied to a data processing device. Difference in hard disk 41′″ of data processing device 4′″ of the present embodiment from the hard disk in the first, the second, and the third embodiments is that the hard disk 41′″ is not installed with a file sharing software. However, in order to enable the data processing device 4′″ to also have file a sharing function, as shown in FIG. 7, in addition to the automatic execution program 520″, a program storage unit 52′″ of the data write/read auxiliary device 5′″ of the preset embodiment further stores a data write/read program 523. Since those components of the first and the present embodiments sharing a same component name have same operation and process, no repeated description is given thereinafter hence to simplify description, and only the difference is given as following.

After the data processing device 4′″ is connecting with the data write/read auxiliary device 5′″ and also identifies the data write/read auxiliary device 5′″, the data processing device 4′″ will set a data storage unit 51′″ provided by the data write/read auxiliary device 5′″ as a data storage destination (same as when a portable disk is externally connecting to a general computer, operating system installed in the computer will detect the portable disk and a disk number of a storage equipment being allocated with the portable disk, namely commonly named A slot, B slot, C slot, and D slot, therefore).

Next, the data processing device 4′″ executes the data write/read program 523 stored in the program storage unit 52′″. The data write/read program 523 is mainly for enabling the data processing device 4′″ to search providers that are capable of providing requested data to local end of the data processing device 4′″ via the network system 2, and download the data provided by the provider via the network system 2 and store the data to the data storage unit 51′″ preset as the data storage destination. When the local end of the data processing device 4′″ receives a request of data demand sent from the network system 2, the saved downloaded data matching with the requested data demand is retrieved from the data storage unit 51′″ and then uploaded to the requester sending out the request via the network system 2.

Tasks executed by the data write/read program 523 of the present embodiment are similar to those executed by a file sharing software, such as BT or eMule software. The only difference between the data write/read program 523 and the conventional file sharing software is: when the data processing device 4′″ is storing data downloaded from the network system or is uploading saved data via the network system, the target of data access by local end of the data processing device 4′″ is the data write/read auxiliary device 5′″. By contrast, when executing a file sharing software, frequent access to hard disk 41′″ of the data processing device 4′″ happens. Therefore, the data write/read auxiliary device 5′″ of the present embodiment provides a means for avoiding frequent access to hard disk 41′″ for writing/reading data, and further protecting hard disk 41′″. Furthermore, the data write/read auxiliary device 5′″ of the present embodiment allowing users, in various particular situations, to upload and download data speedily and easily via a data processing device in that particular situation. Also, via the data write/read auxiliary device 5′″, more convenience to the user for sharing downloaded data at any place is provided.

It should be stated herein, although an USB portable disk is being used as an example of the data write/read auxiliary device 5′″ of the present embodiment, but not restricted to this type, any retrievable type of flash memory card as applied to the data write/read auxiliary device 5′ shown in FIG. 4 is also applicable to the present embodiment, in order to simplify illustration, no further diagram is provided herein hence.

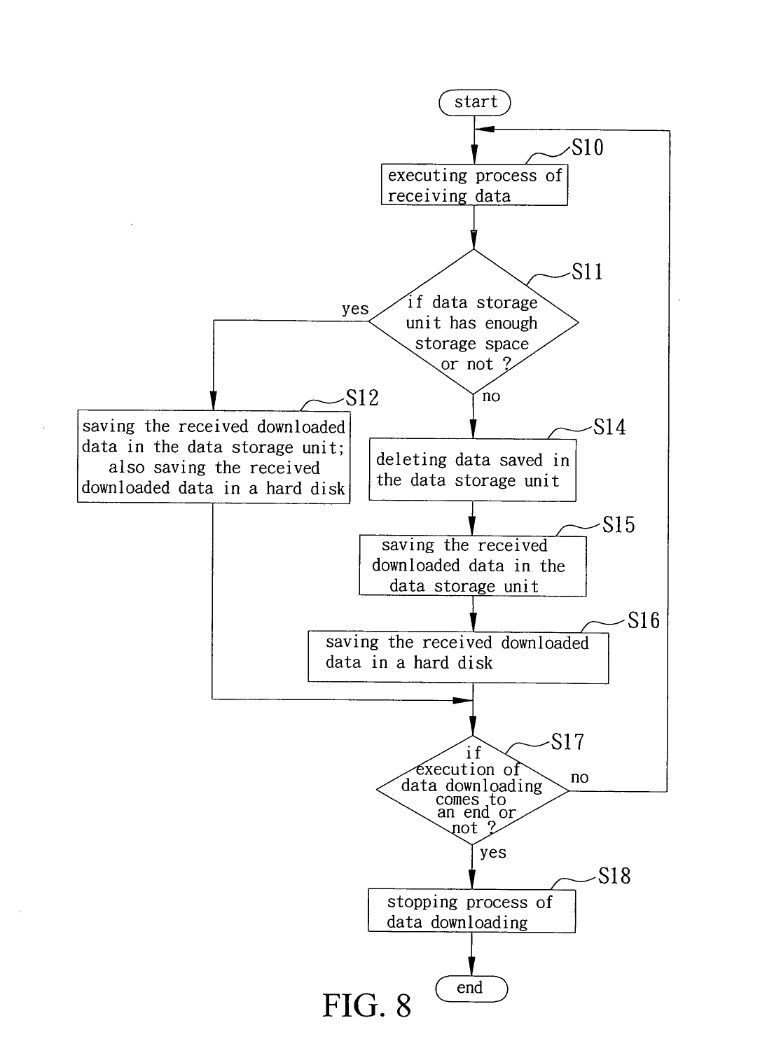

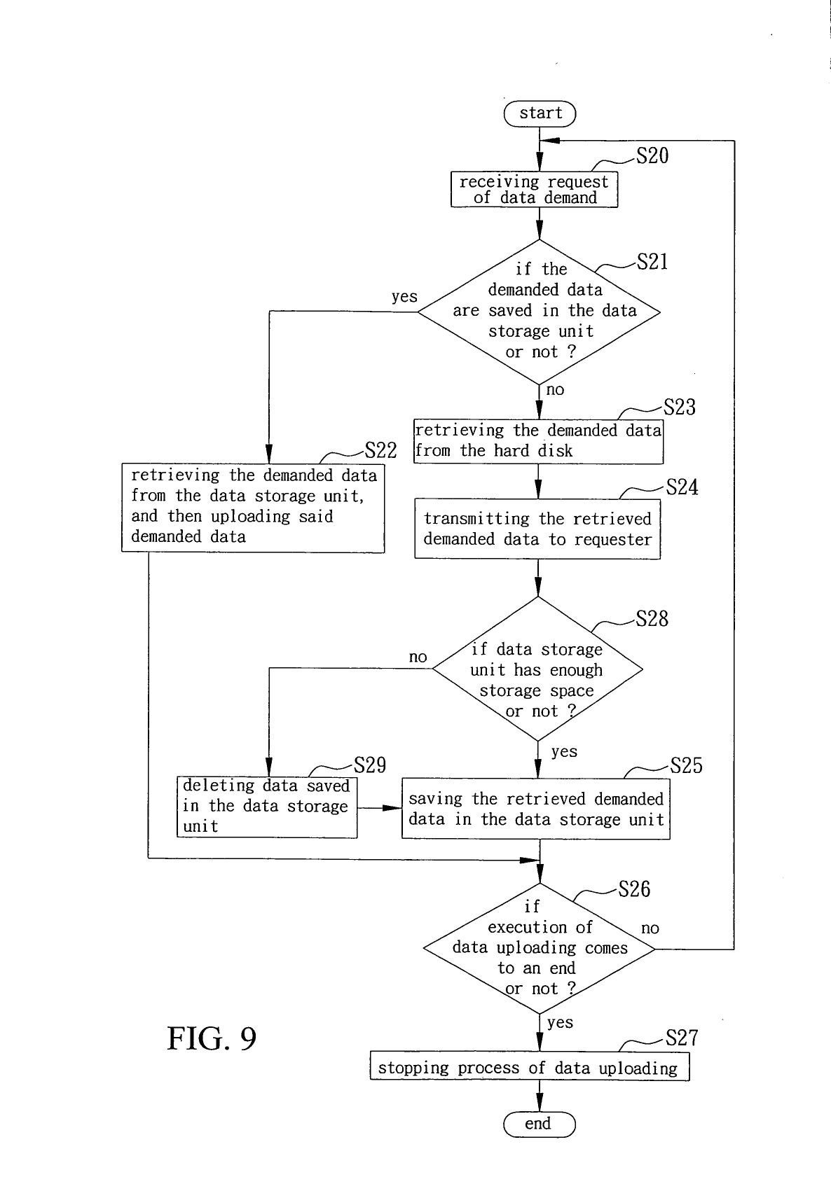

FIGS. 8 and 9 are flow charts respectively illustrating processes of executing data downloading and data uploading according to the first embodiment of the method for writing/reading data of the present invention. The method for writing/reading data of the present embodiment is executable in the data write/read auxiliary device shown in the first, the second, and the third embodiments. However, not restricted to stated herein, the method is executable in any electronic equipment that includes a data storage unit and a program storage unit with automatic execution program and protection program stored therein. The timing for executing the method for writing/reading data are: when data downloaded from the network system is saved to the hard disk of the data processing device is saving and when the saved data is uploaded from the hard disk to the network system. Followed is description pertaining to data downloading, as shown in FIG. 8, step S10 is firstly executed. The data processing device executes a process of downloading data according to a demand request sent from a requester of local end, namely the download data matching with the demand request is received through the file sharing software via the network system. Next, proceeding to step S11.

In the step S11, the data processing device executes the protection program of the data write/read auxiliary device, and then based on received downloaded data, judging if a storage space of the data storage unit provided by the data write/read auxiliary device is sufficient for storing downloaded data or not, if sufficient, then proceeding to step S12; otherwise, proceeding to step S14.

In the step S12, the data processing device saves the received downloaded data in the data storage unit of the data write/read auxiliary device, also the data processing device further stores the received downloaded data in the hard disk; next, proceeding to step S17.

In the step S14, since the data processing device judges that the storage space of the data storage unit provided by the data write/read auxiliary device is not sufficient for storing the received downloaded data, data stored in the data storage unit is deleted; next, proceeding to step S15.

In the step S15, the data processing device saves the received downloaded data in the data storage unit of the data write/read auxiliary device; and next, proceeding to step S16.

In the step S16, the data processing device further stores the received downloaded data in the hard disk; next, proceeding to step S17.

In the step S17, the data processing device judges that if the request of data downloading of the file sharing software is terminated, if yes, then proceeding to step S18; otherwise, proceeding back to step S10, thereby allowing the data processing device to keep receiving data requested by the requester of local end.

In the step S18, the data processing device stops executing process of downloading data, namely stopping executing the method for writing/reading data of the present invention.

Furthermore, in said step S12 and step S15 of the method for writing/reading data of the present embodiment, the protection program further provides a sorting process of the downloaded data, for instance, if the downloaded data belong to particular sorts of data, such as commercials, frauds, or viruses, then prohibiting these sorts of downloaded data from being saved in the hard disk but only being saved in the data storage unit of the data write/read auxiliary device, thereby preventing unnecessary data from being stored in the hard disk.

Next, as shown in FIG. 9, which is a flow chart illustrating process of executing data uploading according to the first embodiment of the method for writing/reading data of the present invention applied to a data processing device. Step S20 is firstly executed, the data processing device executes the file sharing software for receiving the request of data demand sent from the network system; next, proceeding to step S21.

In the step S21, the data processing device executes the protection program of the data write/read auxiliary device for judging, according to the received request of data demand, whether demanded data of the data demand request is already been stored in the data storage unit of the data write/read auxiliary device or not, if the data storage unit of the data write/read auxiliary device has already stored the demanded data, then proceeding to step S22; otherwise, proceeding to step S23.

In the step S22, the data processing device retrieves the demanded data stored in the data storage unit of the data write/read auxiliary device, and then provides the demanded data to requester sending out the request of data demand via the network system; next, proceeding to step S26.

In the step S23, since the data storage unit of the data write/read auxiliary device does not store the demanded data, the data processing device retrieves the demanded data from the storage sectors of the hard disk; next, proceeding to step S24.

In the step S24, the data processing device provides the retrieved demanded data to the requester sending out the request of data demand via the network system; next, proceeding to step S28.

In the step S28, the data processing device executes the protection program of the data write/read auxiliary device, and then based on the retrieved demanded data, judging if a storage space of the data storage unit provided by the data write/read auxiliary device is sufficient for storing the retrieved demanded data or not, if sufficient, then proceeding to step S25; otherwise, proceeding to step S29.

In the step S29, since the data processing device judges that the storage space of the data storage unit provided by the data write/read auxiliary device is not sufficient for storing the retrieved demanded data, data stored in the data storage unit is deleted; next, proceeding to step S25.

In the step S25, the data processing device further stores the retrieved demanded data in the data storage unit of the data write/read auxiliary device; next, proceeding to step S26. It should be stated herein, a major reason for further storing the demanded data in the data storage unit is that data being requested for uploading are generally in higher demand, and in order to respond to requests of demand from other requesters meanwhile avoid repeatedly driving hard disk head to access to storage sectors of the hard disk, the approach is to further save the demanded data that is retrieved from the storage sectors of the hard disk in the data storage unit of the data write/read auxiliary device.

In the step S26, the data processing device judges that if the request of data uploading of the file sharing software is terminated, if yes, proceeding to step S27; otherwise, proceeding back to the step S20, thereby allowing the data processing device to keep receiving the requests of demand sent from the network system.

In the step S27, the data processing device stops processing data uploading, namely ending executing the method of accessing data of the present invention.

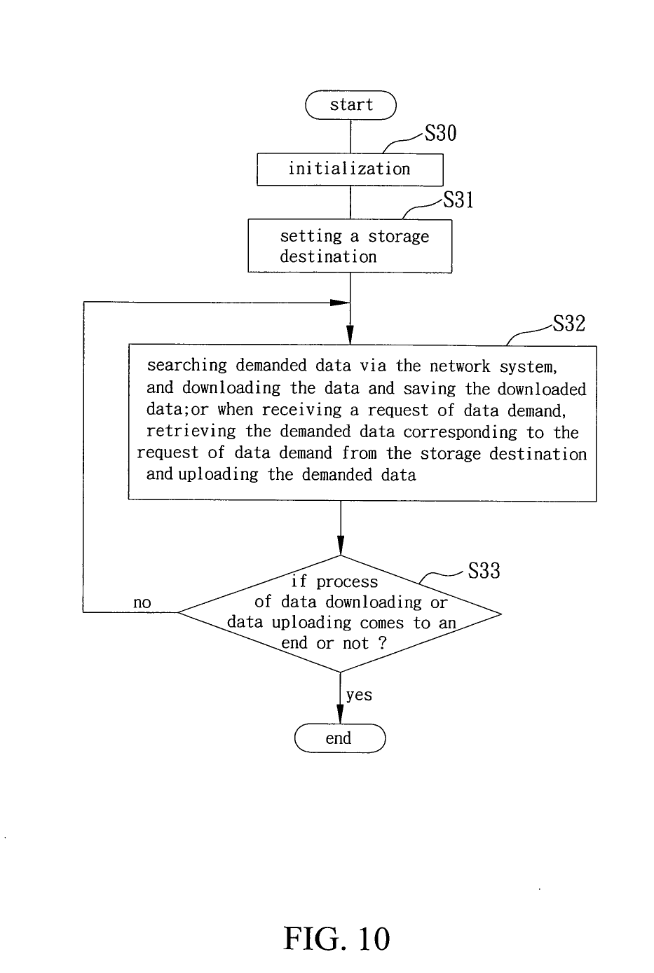

FIG. 10 is a flow chart illustrating process of executing data download and upload according to a second embodiment of the method for writing/reading data of the present invention. The method for writing/reading data of the present embodiment is executable in the data write/read auxiliary device illustrated in the fourth embodiment. However, not restricted to stated herein, the method is executable in any electronic equipment that includes a data storage unit and a program storage unit storing with automatic execution program and data write/read program. Timing for executing the method for writing/reading data is when the data processing device is saving data downloaded from the network system or is uploading the data to be uploaded to the network system. In the processes of data downloading and data uploading, there is no need to access to the hard disk, thereby protecting the hard disk. As shown in the FIG. 10, first executing step S30, the data processing device executes an initialization process, the initialization process is executed after the data write/read auxiliary device is connecting to the data processing device, wherein the data processing device sends out a request of connection, thereby enabling the data processing device to execute the automatic execution program stored in the data write/read auxiliary device as well as identify the data write/read auxiliary device, namely, enabling the data write/read auxiliary device to have Hot plug function and Plug & Play function; next, proceeding to step S31.

In the step S31, after the data processing device completes the initialization process and then identifies the data write/read auxiliary device, setting a data storage unit provided by the data write/read auxiliary device as an data storage destination; next, proceeding to step S32.

In the step S32, searching for provider that is capable of providing demanded data requested by local client of the data processing device via the network system, and then downloading data provided by the provider via the network system and saving the downloaded data in the data storage unit set as the data storage destination; or when receiving a request of data demand sent from the network system, retrieving the data to be uploaded corresponding to the request of data demand and stored in the data storage unit set as the data storage destination, and then uploading the demanded data to a requester sending out the request of demanded data via the network system; next, proceeding to step S33.

In the step S33, the data processing device judges that if execution of process of data downloading or data uploading is terminated, if yes, then ending executing the method for writing/reading data of the present embodiment; otherwise, proceeding back to step S32, enabling the data processing device to keep receiving data requested by local end or uploading data to the network system.

Furthermore, in said step S32 of the method for writing/reading data of the present embodiment, further includes a sorting process of the downloaded data. For instance, if the downloaded data belong to particular sorts of data, such as commercials, frauds, or viruses, then differentiating these types of downloaded data and saving these differentiated types of downloaded data in a particular block of data storage unit of the data write/read auxiliary device, thereby enabling user to manage and maintain the downloaded data.

In view of the above, when a data processing device is applying the method for writing/reading data of the present embodiment to download or upload data, data access is not the same as in executing a prior file sharing software, wherein repeated access to hard disk happens. Therefore, the present embodiment is capable of protecting the hard disk effectively. In addition, the method of the present embodiment provides users a great convenience to speedily and easily complete data downloading and data uploading any time at any place, and the method for writing/reading data further allows the users to share the downloaded data conveniently at any place.

In summary, the data write/read auxiliary device and the method for writing/reading data of the present invention are characterized by using a data storage unit, e.g. flash memory, as a buffer area of data before reading/wring data from/to a hard disk. Therefore, after a data processing device is executing a file sharing software for downloading data from a network system, the downloaded data is saved in the data storage unit. Accordingly, when the data processing device receives some requests of file sharing from the network system, the data storage unit is capable of providing file requesters of the network system with the requested file, namely, the buffer area of data provides a means of retrieving a requested file without frequently accessing to the hard disk. Furthermore, according to the prior art, when the file sharing software is used to speedily download the requested files, frequent access to particular sectors of the hard disk wherein downloaded data are stored always happens due to executing the file sharing software. By contrast, since the data storage unit of the present invention is capable of providing the requested file to the file requesters of the network system, the frequent access to the hard disk happening in the prior art is avoided, thereby protecting the hard disk.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A data write/read auxiliary device for applying to a data processing device that executes a file sharing software, wherein the data write/read auxiliary device is used for reducing rotation and reading frequency of a write/read head of a hard disk to protect the hard disk when downloaded data from a network system are saved to the hard disk of the data processing device or when data to be uploaded are uploaded from the hard disk to the network system, the data write/read auxiliary device comprising:
an interface unit for connecting the data write/read auxiliary device to the data processing device;
a data storage unit connected to the interface unit; and
a program storage unit connected to the interface unit and used for storing automatic execution program and protection program,
wherein the automatic execution program enables the data processing device to automatically execute all programs saved in the program storage unit when the data write/read auxiliary device is connected to the data processing device, the protection program is executed after identifying the data write/read auxiliary device by the data processing device, and the protection program is for reading storage sector addresses of the hard disk in which the downloaded data and the data to be uploaded are saved while the data processing device is executing the file sharing software, when the file sharing software is executing a process of downloading data, the protection program judges if a storage space provided by the data storage unit is sufficient to save the downloaded data, and saves the downloaded data to the data storage unit and further to an idle area of the storage sector of the hard disk according to the storage sector addresses when the storage space is sufficient, or deletes data stored in the data storage unit to save the downloaded data to the data storage unit and further to the idle area of the storage sector of the hard disk according to the storage sector addresses when the storage space is insufficient; and when the file sharing software is executing a process of uploading data, the protection program judges if the data to be uploaded are stored in the data storage unit, and uploads the data to be uploaded to the network system when the data to be uploaded are stored in the data storage unit, or retrieves the data to be uploaded from the storage sector of the hard disk according to the storage sector addresses to upload the data to be uploaded to the network system and save the data to be uploaded to the data storage unit when the data to be uploaded are not stored in the data storage unit.

2. The data write/read auxiliary device of claim 1, wherein the data write/read auxiliary device is an USB portable disk, the interface unit is an USB connection head, and the data processing device comprises a corresponding USB interface.

3. The data write/read auxiliary device of claim 1, wherein the protection program further provides a sorting process of the downloaded data for prohibiting particular sorts of the downloaded data from being saved in the hard disk but only being saved in the data storage unit of the data write/read auxiliary device to prevent the particular sorts of the downloaded data from being stored in the hard disk.

4. A method for writing/reading data, wherein the method for writing/reading data is used for reducing rotation and reading frequency of a write/read head of a hard disk to protect the hard disk when a file sharing software is executed by a data processing device for saving downloaded data from a network system to the hard disk of the data processing device and uploading data to be uploaded from the hard disk to the network system, the method for writing/reading data comprising:
executing an automatic execution program by the data processing device for automatically executing all programs stored in a program storage unit;
executing a protection program stored in the program storage unit by the data processing device to read storage sector addresses of the hard disk in which the downloaded data and the data to be uploaded are saved when the data processing device is executing the file sharing software;
commanding the protection program to judge if a storage space provided by the data storage unit is sufficient to save the downloaded data when the file sharing software is executing a process of downloading data, and saving the downloaded data to the data storage unit and further to an idle area of the storage sector of the hard disk according to the storage sector addresses by the protection program when the storage space is sufficient, or deleting data stored in the data storage unit to save the downloaded data to the data storage unit and further to the idle area of the storage sector of the hard disk according to the storage sector addresses when the storage space is insufficient; and
commanding the protection program to judge if the data to be uploaded are stored in the data storage unit when the file sharing software is executing a process of uploading data, and uploading the data to be uploaded from the data storage unit to the network system when the data to be uploaded are stored in the data storage unit, or retrieving the data to be uploaded from the storage sector of the hard disk according to the storage sector addresses to upload the data to be uploaded to the network system and saving the data to be uploaded to the data storage unit when the data to be uploaded are not stored in the data storage unit.

5. The method for writing/reading data of claim 4, wherein the protection program further provides a sorting process of the downloaded data for prohibiting particular sorts of the downloaded data from being saved in the hard disk but only being saved in the data storage unit.

6. The method for writing/reading data of claim 4, wherein the data storage unit and the program storage unit are built in a data write/read auxiliary device, the program storage unit stores the automatic execution program and the protection program, the data write/read auxiliary device is an USB portable disk, the data write/read auxiliary device is connected to the data processing device by an USB connection head, and the data processing device comprises an USB interface for connecting with the USB connection head.

7. The method for writing/reading data of claim 6, wherein the protection program further provides a sorting process of the downloaded data for prohibiting particular sorts of the downloaded data from being saved in the hard disk but only being saved in the data storage unit.

8. The method for writing/reading data of claim 4, wherein the program storage unit is built in a data write/read auxiliary device, the program storage unit stores the automatic execution program and the protection program, the data storage unit is built in a storage block provided by memory of the data processing device, the storage block is built by dividing a storage space provided by the memory of the data processing device through the protection program, the data write/read auxiliary device is an USB portable disk, the data write/read auxiliary device is connected to the data processing device by an USB connection head, and the data processing device comprises an USB interface for connecting with the USB connection head.

9. The method for writing/reading data of claim 8, wherein the protection program further provides a sorting process of the downloaded data for prohibiting particular sorts of downloaded data from being saved in the hard disk but only being saved in the data storage unit.

10. The method for writing/reading data of claim 4, wherein the data storage unit and the program storage unit are built in a data write/read auxiliary device, wherein the program storage unit stores the automatic execution program and the protection program, the data write/read auxiliary device is a flash memory card, the program storage unit and the data storage unit are flash memories of the flash memory card, the data processing device comprises a card reader for building a connection between the flash memory card and the data processing device.

11. The method for writing/reading data of claim 10, wherein the card reader is either built inside the data processing device or externally connected to the data processing device.

12. The method for writing/reading data of claim 10, wherein the protection program further provides a sorting process of the downloaded data for prohibiting particular sorts of the downloaded data from being saved in the hard disk but only being saved in the data storage unit.

13. A method for writing/reading data for saving downloaded data from a network system by a data processing device and uploading the downloaded data to the network system, the method for writing/reading data comprising:
executing an automatic execution program by the data processing device for automatically executing all programs saved in a program storage unit, and setting a data storage unit as a data storage destination; and
executing a data write/read program stored in the program storage unit by the data processing device for searching a provider via the network system to provide local end of the data processing device with the downloaded data, downloading the downloaded data provided by the provider via the network system and saving the downloaded data in the data storage unit set as the data storage destination; and when receiving a request of data demand sent via the network system, responsively retrieving the downloaded data corresponding to the request of data demand from the data storage unit and uploading the downloaded data to a requester providing the request of data demand via the network system.

14. The method for writing/reading data of claim 13, wherein the data write/read program further provides a sorting process of the downloaded data for differentiating particular sorts of the downloaded data and saving the particular sorts of the downloaded data in specific blocks of the data storage unit.

15. The method for writing/reading data of claim 13, wherein the data storage unit and the program storage unit are built in a data write/read auxiliary device, the program storage unit stores the automatic execution program and the data write/read program, the data write/read auxiliary device is an USB portable disk, the data write/read auxiliary device is connected to the data processing device by an USB connection head, and the data processing device comprises an USB interface for connecting with the USB connection head.

16. The method for writing/reading data of claim 15, wherein the data write/read program further provides a sorting process of the downloaded data for differentiating particular sorts of downloaded data and saving the particular sorts of downloaded data in specific blocks of the data storage unit.

17. The method for writing/reading data of claim 13, wherein the program storage unit is built in a data write/read auxiliary device, the program storage unit stores the automatic execution program and the data write/read program, the data storage unit is built in a storage block provided by memory of the data processing device, the storage block is built by dividing a storage space provided by the memory of the data processing device through the protection program, the data write/read auxiliary device is an USB portable disk, the data write/read auxiliary device is connected to the data processing device by using an USB connection head, and the data processing device comprises an USB interface for connecting with the USB connection head.

18. The method for writing/reading data of claim 17, wherein the data write/read program further provides a sorting process of the downloaded data for differentiating particular sorts of downloaded data and saving the particular sorts of downloaded data in specific blocks of the data storage unit.

19. The method for writing/reading data of claim 13, wherein the data storage unit and the program storage unit are built in a data write/read auxiliary device, wherein the program storage unit stores the automatic execution program and the data write/read program, the data write/read auxiliary device is a flash memory card, the program storage unit and the data storage unit are flash memories of the flash memory card, and the data processing device comprises a card reader for building a connection between the flash memory card and the data processing device.

20. The method for writing/reading data of claim 19, wherein the card reader is either built inside the data processing device or externally connected to the data processing device.

21. The method for writing/reading data of claim 19, wherein the data write/read program further provides a sorting process of the downloaded data for differentiating particular sorts of downloaded data and saving the particular sorts of downloaded data in specific blocks of the data storage unit.
